(19) United States
(12) Patent Application Publication
(10) Pub. No.: US 2010/0257370 A1
(43) Pub. Date: Oct. 7, 2010

(54) Apparatus And Method for Supporting Content Exchange Between Different DRM Domains

(76) Inventors: Ki Song Yoon, Daejeon (KR); Yeon Jeong Jeong, Daejeon (KR); Seong Oun Hwang, Daejeon (KR); Do Won Nam, Daejeon (KR); Jeong Hyun Kim, Daejeon (KR); Ji Hyun Park, Daejeon (KR); Sang Won Jeong, Daejeon (KR); Jun II Kim, Kyunggi-do (KR); Seong Min Ahn, Seoul (KR); Seong Han Kim, Kyunggi-do (KR); Wan Ho Jang, Kyunggi-do (KR)

Correspondence Address: MORGAN, LEWIS & BOCKIUS, LLP. (PA), 2 PALO ALTO SQUARE, 3000 EL CAMINO REAL, SUITE 700, PALO ALTO, CA, 94306, US

(21) Appl. No.: 11/665,985

(22) PCT Filed: Oct. 20, 2005
(86) PCT No.: PCT/KR2005/003494

§ 371 Date: Sep. 4, 2008

(30) Foreign Application Priority Data
Oct. 20, 2004 (KR) 10-2004-0084181
Apr. 22, 2005 (KR) 10-2005-0033480

(51) Int. Cl. G06F 21/24; G06F 12/14

(52) U.S. Cl. 713/189; 726/30; 726/29

(57) ABSTRACT

Provided is a system for exchanging contents between a first DRM apparatus and a second DRM apparatus, wherein each of which belongs to different DRM domain. The first DRM apparatus includes unpackaging means for unpackaging first DRM formatted contents into clear resources, metadata, and rights expression; converting means for converting each of the clear resources, metadata, and rights expression into its own predefined neutral format, respectively; generating means for generating neutral formatted contents by combining the converted resources, metadata, and rights expression; adding predetermined header information thereto; and transmitting means for transmitting the neutral-formatted contents to said second DRM apparatus. The second DRM apparatus includes extracting means for extracting clear resources, metadata, and rights expression from the neutral-formatted contents transmitted from said first DRM apparatus; and packaging means for packaging the extracted clear resources, metadata, and rights expression into second DRM formatted contents.

### BACKGROUND ART

1. Field of the Invention

The present invention relates to digital rights management (DRM) mechanism and, more particularly, to method and apparatus for exchanging contents between different DRM domains.

2. Description of Related Art

In general, audio, video and other contents in different DRM domains, which are provided through various wired, wireless, and broadcasting networks such as the Internet and other wireless communications networks, can only be executed by the corresponding DRM devices. Recently, various DRM devices have come into widespread use. However, since they do not provide interoperability and cannot execute the contents governed by different DRM domains, access to various contents is limited. Even though various devices, such as MP3 players, cellular phones, portable audio/video (PAV) devices, etc, are used by the same user, it is impossible to exchange contents between the devices each of which uses different DRM devices. Accordingly, the usefulness of the contents would be restricted. Even if a universal DRM device supporting all DRM formats were developed, since conventional DRM devices are not still compatible with various different DRM formats, users demands for access to various contents will not be satisfied.

Thus, there is an urgent need for mechanism for supporting content exchange between different DRM format devices.

### SUMMARY OF THE INVENTION

The present invention is directed to a data structure of neutral-formatted contents that enables contents to be exchanged between different DRM domains.

The present invention is also directed to an apparatus and method for supporting effective content exchange between different DRM format devices by using neutral-formatted contents.

A first aspect of the present invention provides an apparatus for exporting given DRM formatted contents to a target DRM apparatus with a different DRM format. The apparatus comprises means for unpackaging the given DRM formatted contents into clear resources, metadata, and rights expression; means for converting each of the unpackaged clear resources, metadata, and rights expression into its own predefined neutral format, respectively; and means for generating neutral-formatted contents by combining the converted resources, metadata, and rights expression and adding predetermined header information thereto; and means for transmitting the neutral-formatted contents to the target DRM apparatus.

A second aspect of the present invention provides an apparatus for importing predefined neutral-formatted contents in a given DRM domain, comprising extracting means for extracting clear resources, metadata, and rights expression from the predefined neutral-formatted contents; and packaging means for packaging the extracted clear resources, metadata, and rights expression into the given DRM formatted contents, wherein the given DRM formatted contents are executed by various DRM apparatuses in the given DRM domain.

A third aspect of the present invention provides an apparatus for exporting and importing contents. The apparatus comprises means for unpackaging contents in its own DRM format into clear resources, metadata, and rights expression; means for converting each of the unpackaged clear resources, metadata, and rights expression into a predefined neutral format, respectively; and means for generating neutral-formatted contents by combining the converted resources, metadata, and rights expression and adding predetermined header information thereto; means for transmitting the neutral-formatted contents to different DRM domain; means for extracting clear resources, metadata, and rights expression from neutral-formatted contents transmitted from a different DRM domain; and means for packaging the extracted clear resources, metadata, and rights expression into given DRM formatted contents.

A fourth aspect of the present invention provides a method for exporting given DRM formatted contents to a target DRM apparatus with a different DRM format. The method comprises the steps of unpackaging the given DRM formatted contents into clear resources, metadata, and rights expression; converting each of the unpackaged clear resources, metadata, and rights expression into its own predefined neutral format, respectively; and generating neutral-formatted contents by combining the converted resources, metadata, and rights expression and adding predetermined header information thereto; and transmitting the neutral-formatted contents to the target DRM apparatus.

A fifth aspect of the present invention provides a method of importing predetermined neutral-formatted contents in a given DRM domain, comprising the steps of extracting clear resources, metadata, and rights expression from the predefined neutral formatted contents; and packaging the extracted clear resources, metadata, and rights expression into the given DRM formatted contents, wherein the given DRM formatted contents are executed by various DRM apparatuses in the given DRM domain.

A sixth aspect of the present invention provides a method of exporting and importing contents, comprising the steps of unpackaging given DRM formatted contents into clear resources, metadata, and rights expression; converting each of the unpackaged clear resources, metadata, and rights expression into its own predefined neutral format, respectively; and generating neutral-formatted contents by combining the converted resources, metadata, and rights expression and adding predetermined header information thereto; transmitting the neutral-formatted contents to a different DRM domain; extracting clear resources, metadata, and rights expression from the neutral-formatted contents transmitted from a different DRM domain; and packaging the extracted clear resources, metadata, and rights expression into given DRM formatted contents.

A seventh aspect of the present invention provides a data structure of a neutral format of contents that are exchangeable between DRM apparatuses in different DRM domains. The data structure comprises header part and body part. The header part includes version of the neutral format; header length; resource encryption algorithm type and resource encryption key; type of hash algorithm applied to the header and the body part and a hash code value; and type of digital signature algorithm and a digital signature value; and the body part includes resources encrypted using the resource encryption algorithm; rights expression in its own predefined neutral format; and metadata in its own predefined neutral format.

An eighth aspect of the present invention provides system for exchanging contents between a first DRM apparatus and a second DRM apparatus, wherein each of which belongs to a different DRM domain. The first DRM apparatus includes unpackaging means for unpackaging first DRM formatted contents into clear resources, metadata, and rights expression; converting means for converting each of the clear resources, metadata, and rights expression into a corresponding neutral format, respectively; generating means for generating neutral formatted contents by combining the converted resources, metadata, and rights expression and adding predetermined header information thereto; and transmitting means for transmitting the neutral-formatted contents to said second DRM apparatus. The second DRM apparatus includes extracting means for extracting clear resources, metadata, and rights expression from the neutral-formatted contents transmitted from said first DRM apparatus; and packaging means for packaging the extracted clear resources, metadata, and rights expression into second DRM formatted contents.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 is a diagram illustrating a process for exchanging contents between different DRM clients according to the present invention.

FIG. 2 is a diagram illustrating the adaptation process according to an exemplary embodiment of the present invention;

FIG. 3 shows a data structure of the contents in a neutral format according to an exemplary embodiment of the present invention;

FIG. 4 shows main components of a source DRM client (DRM A) and a target DRM client (DRM B) for exporting/importing contents according to an exemplary embodiment of the present invention;

FIG. 5 is a diagram illustrating an export/import software authentication process according to an exemplary embodiment of the present invention;

FIG. 6 is a diagram illustrating a key exchange process between the source export/import module and the target export/import module according to an exemplary embodiment of the present invention;

FIG. 7 is a diagram illustrating a device authentication process according to an exemplary embodiment of the present invention; and

FIG. 8 shows a diagram that more specifically illustrates the export/import process between the different DRM clients according to an exemplary embodiment of the present invention.

### DETAILED DESCRIPTION OF THE PREFERRED EMBODIMENTS

Before describing the present invention in detail, some terms used in this specification will be defined.

“DRM” stands for digital rights management.

“Clear resources” represent the information that can be rendered in a form that is meaningful to users, such as mp3 files.

“Packaging” refers to an operation for producing contents in which clear resources, metadata and rights expression are combined. Software for performing packaging is called a “packager.”

“Unpackaging” refers to an operating for extracting clear resources, metadata and rights expression from the contents. Software for performing unpackaging is called an “Unpackager.”

“PAV” stands for portable audio video device. PAVs are used for reproducing/executing audio and/or video contents.

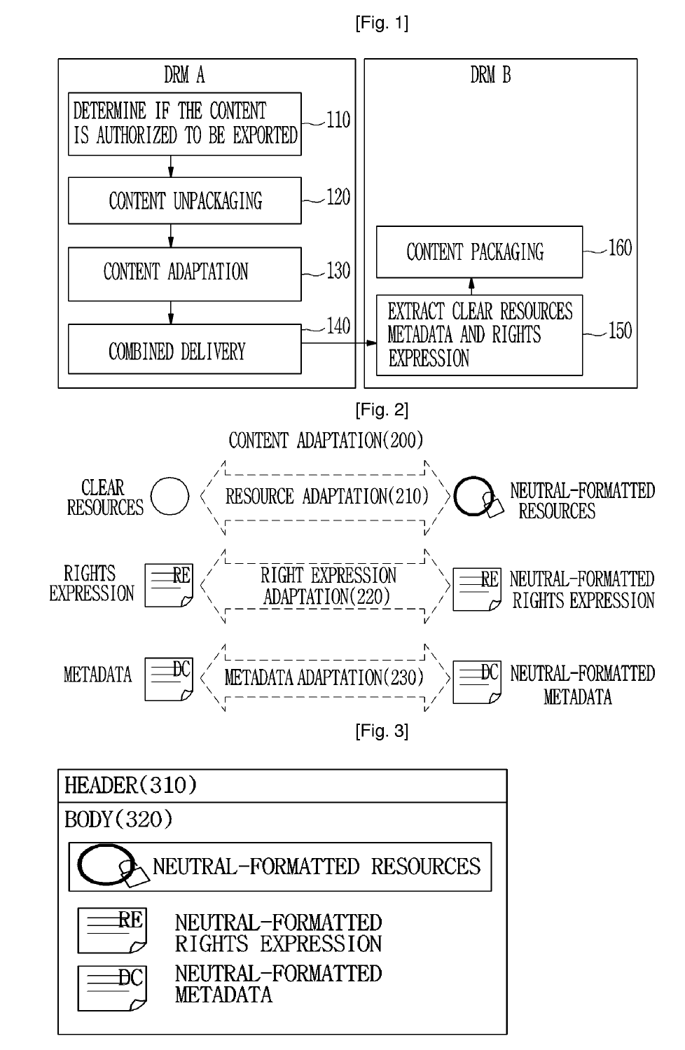

FIG. 1 is a diagram illustrating a process for exchanging contents between different DRM clients according to the present invention. It is assumed that the DRM A client desires to export (transmit) contents and the DRM B client desires to import (receive) it. As shown in FIG. 1, in step 110, it is checked if the contents have authorization to be exported, by referring to the rights expression contained in the contents.

If the contents have been determined to have authorization to be exported, it is then unpackaged into the clear resources, the metadata, and the rights expression in step 120. The unpackaged clear resources, metadata, and rights expression are respectively converted into each predefined neutral format in step 130. This work is called “content adaptation” in this specification. The content adaptation will be explained in detail later with reference to FIG. 2.

In step 140, the resources, the metadata, and the rights expression in their own neutral format are then combined and the header part for additional information is added thereto, so that the neutral formatted-contents are produced and then encrypted. The neutral formatted-contents are transmitted to the DRM B client. This work is called “combined delivery” in this specification. In combined delivery, there are one header and one body including the neutral-formatted resources, metadata and rights expression. The header includes the locations of the body items so that they can be extracted separately. Hash code value is evaluated based on the header and body, except for a hash code value itself, and the digital signature.

In order to accomplish secure contents transfer between the different DRM domains, the neutral-formatted contents are encrypted using, for example, a public key infrastructure (PKI) mechanism or a key sharing mechanism. A basic algorithm necessary to encrypt the contents may include an asymmetric encryption algorithm for secure key transfer and integrity check (e.g., RSA), a resource encryption algorithm (e.g., AES-128), and a hash algorithm (e.g., SHA-1). It is noted that such encryption algorithms are exemplary, and the different algorithms can be selected with the negotiation between source and target DRM clients. In one embodiment, the selected algorithms may be specified in the header part or is reported to the target client through message exchange between the source and target clients.

The DRM B client, which desires to import the neutral-formatted contents, receives and unpackages it into the clear resources, the metadata, and the rights expression (step 150). The extracted clear resources, metadata and rights expression are then re-packaged for adaptation to the DRM B client (step 160). Accordingly, the re-packaged contents can be executed or reproduced by DRM B format devices.

FIG. 2 is a diagram illustrating the adaptation process according to an exemplary embodiment of the present invention. As shown in FIG. 2, the adaptation process 200 for producing the neutral-formatted contents may include a resource adaptation process 210, a rights expression adaptation process 220, and a metadata adaptation process 230. For each adaptation according to the present invention, the corresponding neutral format is defined. It should be guaranteed that the adaptation process 200 takes place in a trusted environment.

The resource adaptation process 210 is the process in which the clear resources received from the source DRM client is converted into predefined neutral-formatted resources, which are not dependent on the specific DRM format devices. The resource adaptation process 210 randomly generates a content encryption key (CEK) to encrypt the clear resources using an encryption algorithm such as AES-128. The key used for encryption may be inserted into the rights expression in the neutral-formatted contents. Hash is evaluated based on both a header and a body, excluding the hash code and the digital signature, and written in the hash code field of the header part. The hash code information is digitally signed using a private key and saved in the digital signature field.

The rights expression adaptation process 220 converts the given rights expression into the corresponding predefined neutral format. In this embodiment, MPEG-21 rights expression language (REL) is used as the neutral format of rights expression. The neutral rights expression can be added or missed depending on the policy or right existence of a source DRM domain and a target DRM domain.

The metadata adaptation process 230 converts the given metadata into the corresponding predefined neutral format. In this embodiment, Dublin Core may be used as the neutral format of metadata. Alternatively, metadata not included in Dublin Core can also be specified in extended XML format with Dublin Core expression. The metadata in extended XML can be recognized by the specific DRM client. The neutral metadata can be added or missed depending on the policy or metadata existence of source DRM domain and target DRM domain.

FIG. 3 shows a data structure of the contents in a neutral format according to an exemplary embodiment of the present invention. As shown in FIG. 3, the data structure of the contents in the neutral format can be adapted to be exchanged between different DRM domains. The data structure of the contents may be composed of a header part 310 and a body part 320. In the header part 310, neutral format version, header length, hash code value calculated based on the header 310 and body 320, resource (or contents) encryption key, a type of encryption algorithm used for encryption of the resources, a digital signature, locations of body items (i.e., resources, rights expression, and metadata), etc. For example, AES-128 may be used as a resource encryption algorithm, and SHA-1 may be used as a hash algorithm for producing the hash code value. However, the fields in the header 310 are not limited to such fields, and some of them may be changed or new fields may be added thereto according to agreement between the DRM format devices.

The body 320 contains the encrypted resources in its own neutral format, the rights expression in its own neutral format, and the metadata in its own neutral format, which have been produced via the content adaptation process 200. In one embodiment, the predefined neutral format of the rights expression may be the MPEG-21 REL, and the predefined neutral format of the metadata may be the Dublin Core metatag.

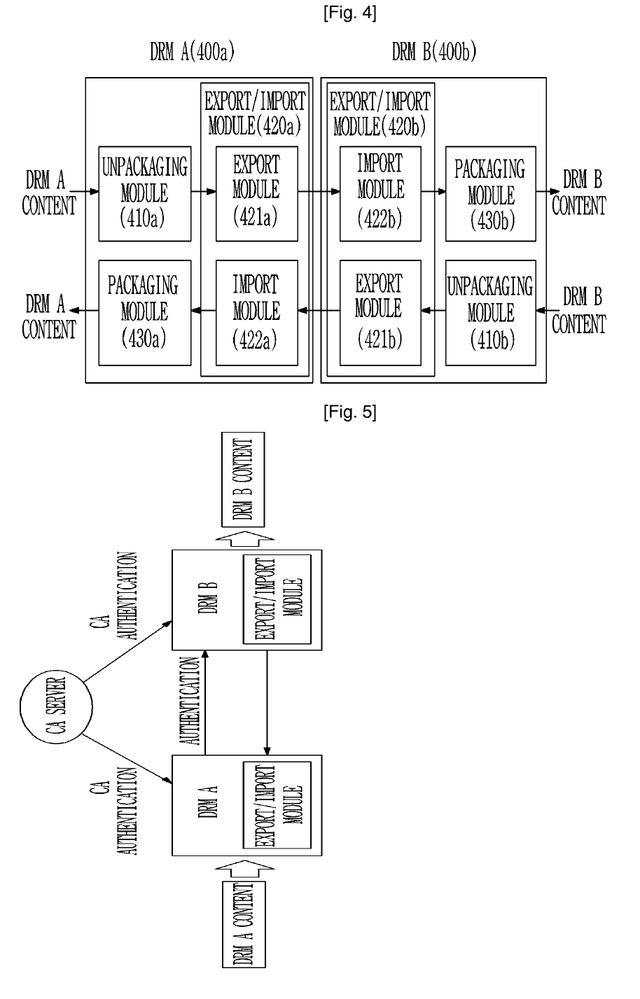

FIG. 4 shows main components of a source DRM client (DRM A) and a target DRM client (DRM B) for exporting/importing contents according to an exemplary embodiment of the present invention. As shown in FIG. 4, the DRM A and DRM B clients 400a and 400b may be data processing system which can produce, manage, export, import and/or execute contents in corresponding formats. For example, the DRM A and DRM B clients may include a PC, a PDA, a cellular phone, etc.

The DRM A client 400a includes an unpackaging module 410a for unpackaging DRM A formatted contents into the clear resources, the rights expression and the metadata; an export/import module 420a for exporting/importing the contents from/to a different DRM client (for example, DRM B client 400b); and a packaging module 430a for packaging the clear resources, the metadata, and the rights expression into the DRM A-formatted contents. In one embodiment, the unpackaging module 410a checks whether or not the DRM A formatted contents have authorization to be exported to the different DRM client, such as DRM B client, and then unpackages only the contents authorized to be exported.

Specifically, the export/import module 420a may include an export submodule 421a and an import submodule 422a. The export submodule 421a packages the clear resources, the metadata, and the rights expression, which have been extracted from the DRM A-formatted contents by the unpackaging module 410a, into the neutral-formatted contents and transmit (or export) it to the target DRM client, i.e., the DRM B client 400b. The import submodule 422a receives (imports) the neutral-formatted contents from the DRM B client and then extracts from it the clear resources, the metadata, and the rights expression. In addition, the export submodule 421a may perform authentication for the target DRM client. Also, in order to safely export the contents, it may authenticate the export/import module at the target DRM client.

The packaging module 430a serves to package the clear resources, the metadata, and the rights expression extracted by the import module 422a into the DRM A-formatted contents.

The DRM B client 400b has substantially the same configuration as the DRM A client 400a, and thus the description thereof is omitted. The drawings are intended to help the understanding of the export/import concept according to the present invention and should not be construed as limiting the physical configuration of the present invention. For example, FIG. 4 shows that the export/import modules 420a and 420b are installed on the DRM A client 400a and the DRM B client 400b, respectively, but the export/import modules could be implemented as an independent device (e.g., export/import server), separate from the DRM clients. In addition, although FIG. 4 shows that contents are exchanged between two different DRM clients, it could be easily understood that the contents may be exchanged among a plurality of different DRM clients, by using the data structure of the neutral format.

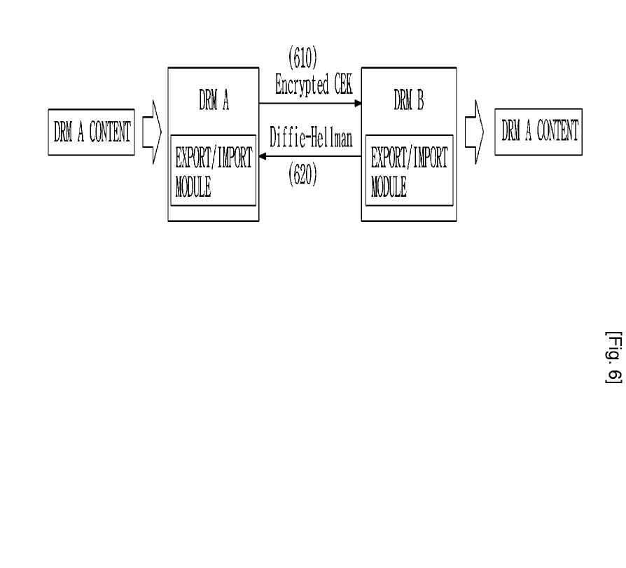

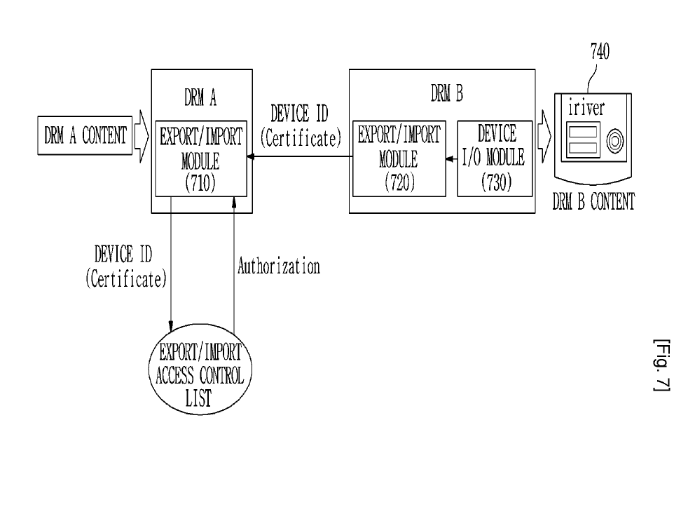

FIG. 5 is a diagram illustrating an export/import software authentication process according to an exemplary embodiment of the present invention. The source export/import software and the target export/import software, which are separately installed in the different DRM clients, authenticate each other for the security purpose, before exchanging the key or communicating each other. Also, it should be confirmed whether both of them are tampered or not. As shown in FIG. 5, the authentication between the export/import software may be performed using a certificate authority (CA) server.

FIG. 6 is a diagram illustrating a key exchange process between the source export/import module and the target export/import module according to an exemplary embodiment of the present invention. When they send and receive messages, the messages should be encrypted for secure transfer against eavesdrops or attacks. Please note that the authentication of the source/target software and devices should be done in advance.

Since the exchange of a content encryption key (CEK) in clear text format between the two modules is not safe, the following two ways may be considered: certificate-based CEK 610 exchange and shared key mechanism for producing the same key at both sides, without exchanging a key, such as Diffie-Hellman algorithm.

FIG. 7 is a diagram illustrating a device authentication process according to an exemplary embodiment of the present invention. Device authentication is to check the target PAV device has been authorized to execute the imported contents. In this embodiment, device authentication is performed based on the export/import access control list. Since the export/import process is to exchange contents over different DRM domains, the process should be under the control depending on business policies and/or technical requirements. In one embodiment, the (source) export/import module 710 of DRM A client first requests from the (target) export/import module 720 for a device certificate of the DRM B format device 740 connected to a device I/O module 730. Assume that the device certificate has been inserted into the device. The (target) export/import module 720 then transmits the device certificate (or identifier) of the DRM B format device 740 to the (source) export/import module 710. The (source) export/import module 710 authenticates the device by checking the device certificate with the export/import access control list. In other embodiment, instead of a device certificate, a device identifier, which has been assigned by a device-identifying server (not shown), may be used to perform device authentication.

In the export/import access control list, for each of access control items, it is listed if it is permitted to be exported/imported. The access control items may include devices with different vendors, models, or versions and/or DRM software with different vendors, models, or versions. The export/import access control list may be downloaded from a related server and updated periodically or non-periodically. Alternatively, the export/import module may access the related server to access the list during the device authentication process.

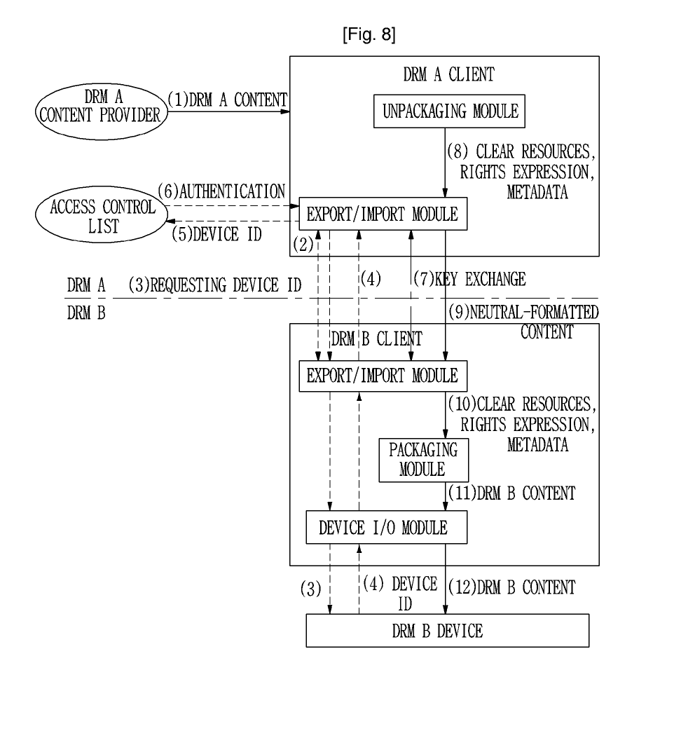

FIG. 8 shows a diagram that more specifically illustrates the export/import process between the different DRM clients according to an exemplary embodiment of the present invention. For convenience, it is assumed the contents are exported from the (source) DRM A client 400a to the (target) DRM B client 400b.

Content purchase: (1)

(1) The DRM A client 400a purchases and downloads DRM A-formatted contents from a DRM content provider (server). In this embodiment, before exporting the downloaded DRM A-formatted contents, the (source) DRM A client checks whether it is authorized to be exported, based on the rights expression in the contents.

Software authentication: (2)

(2) For the sake of safe content exchange, authentication is performed between the source export/import module 420a of the DRM A client and the target export/import module 420b of the DRM B client.

Device authentication: (3)˜(6)

(3) The source export/import module requires the device ID of the DRM B format device connected to the DRM B client, via the target export/import module 420b.

(4) The target export/import module 420b then sends the device ID to the source export/import module 420a.

(5)-(6) The source export/import module 420a authenticates the DRM B format device based on the export/import access control list.

Key exchange between export/import modules: (7)

(7) For security, the key may be exchanged between the source and target export/import modules 420a and 420b.

Export/Import: (8)˜(12)

(8) The unpackaging module 410a of the DRM A client unpackages the DRM A-formatted contents into the clear resources, metadata, and rights expression and then sends them to the source export/import module 420a.

(9) The source export/import module 420a packages the clear resources, metadata and right expression into the neutral format, via the adaptation process, and sends it to the target export/import module 420b.

(10) The target export/import module 420b receives the neutral-formatted contents and extracts the resources, the metadata, and the rights expression from it. It then sends the results to the packaging module 430b.

(11) The packaging module 430b packages then into the DRM B formatted contents, which is executable by the DRM B format device, and sends it to the device I/O module.

(12) The device I/O module transmits it to the DRM B format device.

The present invention can be provided in the form of computer code stored on computer-readable recording media such as floppy disks, hard disks, CD ROMs, flash memory cards, PROM RAM, ROM, and magnetic tape, which can be implemented on one or more different types of products. The computer code may be written in a programming language such as C, C++, or JAVA.

As described above, the present invention provides the content structure having the neutral format for content exchange between the different DRM format devices and the export/import method and device using the same. According to the present invention, by exchanging the contents of the different DRM formats, use of various contents can be supported to thereby satisfy demands of users, convenience of users is increased, and practical use of the contents is also increased.

Although exemplary embodiments of the present invention have been described with reference to the attached drawings, the present invention is not limited to these embodiments, and it should be appreciated to those skilled in the art that a variety of modifications and changes can be made without departing from the spirit and scope of the present invention.

1. An apparatus for exporting given DRM formatted contents to a target DRM apparatus with a different DRM format, the apparatus comprising:
means for unpackaging the given DRM formatted contents into clear resources, metadata, and rights expression; and
means for converting each of the unpackaged clear resources, metadata, and rights expression into its predefined neutral format, respectively; and
means for generating neutral-formatted contents by combining the converted resources, metadata, and rights expression and adding predetermined header information thereto; and
means for transmitting the neutral-formatted contents to the target DRM apparatus.

2. The apparatus of claim 1, further comprising means for determining whether the given DRM formatted contents are authorized to be exported or not.

3. The apparatus of claim 1, wherein said converting means includes means for encrypting the resources using a predetermined encryption algorithm and inserting a resource encryption key into the predefined neutral-formatted rights expression.

4. The apparatus of claim 3, wherein the predetermined resources encryption algorithm includes AES-128.

5. The apparatus of claim 1, wherein the predefined neutral format of the rights expression is MPEG-21 REL.

6. The apparatus of claim 1, wherein the predefined neutral format of the metadata is Dublin Core format.

7. The apparatus of claim 1, wherein the metadata not included in the predefined neutral format is specified in extended XML format with Dublin Core format.

8. The apparatus of claim 1, further comprising encryption means for encrypting the neutral-formatted contents.

9. The apparatus of claim 8, wherein said encryption means encrypts the neutral-formatted contents using a public key infrastructure (PKI) encryption algorithm.

10. The apparatus of claim 9, wherein said encryption means evaluates a hash code value on the neutral-formatted contents, records the hash code value in a hash code field of the header, digitally signs the hash code value using a private key, and records the digitally signed hash code value in a digital signature field of the header.

11. The apparatus of claim 9, further comprising means for transmitting a resource encryption key encrypted by using the public key of the target apparatus to the target DRM apparatus.

12. The apparatus of claim 7, wherein said encryption means encrypts the neutral-formatted contents based on a shared key encryption algorithm.

13. The apparatus of claim 1, further comprising a device authentication means for authenticating a device that is connected to the target DRM apparatus to execute the contents.

14. The apparatus of claim 13, wherein said device authentication means authenticates the device by checking a device certificate, which has been inserted into the device, with an export/import control list provided by a related server.

15. The apparatus of claim 12, wherein said device authentication means authenticates the device by checking a device identifier, which has been assigned to the device by a device identifying server, with an export/import control list provided by a related server.

16. An apparatus for importing predefined neutral-formatted contents in a given DRM domain, comprising:
extracting means for extracting clear resources, metadata, and rights expression from the predefined neutral-formatted contents; and
packaging means for packaging the extracted clear resources, metadata, and rights expression into the given DRM formatted contents;
wherein the given DRM formatted contents are executed by various DRM apparatuses in the given DRM domain.

17. The apparatus of claim 16, wherein said extracting means includes means for decrypting the neutral-formatted contents.

18. An apparatus for exporting and importing contents, comprising:
means for unpackaging contents in its own DRM format into clear resources, metadata, and rights expression;
means for converting each of the unpackaged clear resources, metadata, and rights expression into its own predefined neutral format, respectively; and
means for generating neutral-formatted contents by combining the converted resources, metadata, and rights expression and adding predetermined header information thereto;
means for transmitting the neutral-formatted contents to a different DRM domain;
means for extracting clear resources, metadata, and rights expression from neutral-formatted contents transmitted from a different DRM domain; and
means for packaging the extracted resources, metadata, and rights expression into contents in its own DRM format.

19. A method for exporting given DRM formatted contents to a target DRM apparatus with a different DRM format, the method comprising the steps of:
unpackaging the given DRM formatted contents into clear resources, metadata, and rights expression;
converting each of the unpackaged clear resources, metadata, and rights expression into its own predefined neutral format, respectively; and
generating neutral-formatted contents by combining the converted resources, metadata, and rights expression and adding predetermined header information thereto; and
transmitting the neutral-formatted contents to the target DRM apparatus.

20. The method of claim 19, further comprising the step of determining whether the given DRM formatted contents are authorized to be exported or not.

21. The method of claim 19, wherein said converting step includes the step of encrypting the resources using a predetermined encryption algorithm and inserting an encryption key into the predefined neutral-formatted rights expression.

22. A method of importing predefined neutral-formatted contents in a given DRM domain, comprising the steps of:
extracting clear resources, metadata, and rights expression from the predefined neutral formatted contents; and
packaging the extracted clear resources, metadata, and rights expression into the given DRM formatted contents;
wherein the given DRM formatted contents are executed by various DRM apparatuses in the given DRM domain.

23. A method of exporting and importing contents, comprising the steps of:
unpackaging given DRM formatted contents into clear resources, metadata, and rights expression;
converting each of the unpackaged clear resources, metadata, and rights expression into its own predefined neutral-format, respectively;
generating neutral-formatted contents by combining the converted resources, metadata, and rights expression and adding predetermined header information thereto;
transmitting the neutral-formatted contents to a different DRM domain;
extracting clear resources, metadata, and rights expression from the neutral-formatted contents transmitted from a different DRM domain; and
packaging the extracted clear resources, metadata, and rights expression into given DRM formatted contents.

24. A data structure of a neutral format of contents that are exchangeable between DRM apparatuses in different DRM domains, wherein the data structure comprising header part and body part, the header part including:
version of the neutral format;
header length;
resource encryption algorithm type and a resource encryption key;
type of hash algorithm applied to the header part and the body part and a hash code value; and
a type of digital signature algorithm and a digital signature value; and
the body part including:
resources encrypted using the resource encryption algorithm;
rights expression in its own predefined neutral format; and
metadata in its own predefined neutral format.

25. A system for exchanging contents between a first DRM apparatus and a second DRM apparatus, wherein each of which belongs to a different DRM domain, said first DRM apparatus including:
unpackaging means for unpackaging first DRM formatted contents into clear resources, metadata, and rights expression;
converting means for converting each of the clear resources, metadata, and rights expression into its own predefined neutral format, respectively;
generating means for generating neutral formatted contents by combining the converted resources, metadata, and rights expression; adding predetermined header information thereto; and
transmitting means for transmitting the neutral-formatted contents to said second DRM apparatus; and
said second DRM apparatus including:
extracting means for extracting clear resources, metadata, and rights expression from the neutral-formatted contents transmitted from said first DRM apparatus; and
packaging means for packaging the extracted clear resources, metadata, and
rights expression into second DRM formatted contents.

26. The system of claim 25, wherein said exporting means of said first DRM apparatus performs authentication of said importing means of said second DRM apparatus, before transmitting the neutral-formatted contents to said second DRM apparatus.

27. The system of claim 26, wherein the authentication is performed by a certificate authority server.
